(19) United States
(12) Patent Application Publication
(10) Pub. No.: US 2020/0376619 A1
(43) Pub. Date: Dec. 3, 2020

(54) CHIP EVACUATOR TOOL

(71) Applicant: United Technologies Corporation, Farmington, CT (US)

(72) Inventors: Eric J. Stuckey, Portland, ME (US); Kevin Bachelder, South Berwick, ME (US)

(21) Appl. No.: 16/427,964

(22) Filed: May 31, 2019

(51) Int. Cl. B23Q 11/00

(52) U.S. Cl. CPC B23Q 11/0042

(57) ABSTRACT

A chip evacuator tool includes at least one hook member configured to grab and remove chips from a machined part. The chip evacuator tool is attached to and rotates with a spindle of a machine tool, which is controlled using a computer of a CNC machine. In operation the location of the chip evacuator tool remains stationary while both the chip evacuator tool and the machined part rotate in the same direction, resulting in efficient removal of chips from the machined part.

### BACKGROUND

This disclosure relates generally to a chip evacuator tool. More specifically, this disclosure relates to an automated chip evacuator tool that is controlled using a CNC machine.

During a machining process, unwanted pieces of metal are produced in the form of burrs or chips. Generally, burrs are raised edges or small pieces of material that remain on the edges of the workpiece after a machining process is performed. In contrast, chips are generally long, continuous strands of waste material that are produced during the machining process. Chips are formed due to continuous plastic deformation of metal without fracture in front of the cutting tool, formed by the smooth flow of the chip up the tool face. If the continuous strands of the chips become long enough, the chip can wrap around and interlock with itself as well as the part being machined. The chips must be removed to complete the machining process and to inspect the final machined part, but chips are difficult to handle, remove, and dispose of.

To remove the chips, the current process is to manually stop the machine working on the part and remove the chips by hand. The machinist is required to reach into the machine, grab the sharp chips by hand, and then pull the interlocked chips away from the part and out of the machine. Then the machinist can resume the machining or inspection process that still needs to occur. As such, there is a need for a more efficient process for removing chips from a machined part to increase machine uptime.

### SUMMARY

According to one aspect of the invention, a chip evacuator tool includes a circular body and a first hook member, wherein the circular body includes at least one aperture extending through the circular body. The first hook member extends from the circular body and includes a first arcuate surface and a second arcuate surface that converge at a first tip.

According to another aspect of the invention, a chip removal system includes a machine tool assembly including a translatable spindle and a chip evacuator tool attached to the spindle. The chip evacuator tool includes a circular body with at least one aperture extending through the circular body, and a first hook member extending from the circular body, wherein the first hook member includes a first arcuate surface and a second arcuate surface that converge at a first tip. Further, the machine tool assembly is a computer numerical control (CNC) system that is controlled using a computer.

According to yet another aspect of the invention, a method of removing chips from a machined part includes aligning a chip evacuator tool adjacent the machined part, rotating the chip evacuator tool in a first direction, rotating the machined part in the first direction, and removing the chips from the machined part using the chip evacuator tool. The chip evacuator tool includes a circular body with at least one aperture extending through the circular body and a first hook member extending from the circular body, wherein the first hook member includes a first arcuate surface and a second arcuate surface that converge at a first tip.

### BRIEF DESCRIPTION OF THE DRAWINGS

FIG. 1A is a perspective view of a chip evacuator tool installed in a machine tool assembly.

FIG. 1B is a schematic including the chip evacuator tool, machine tool assembly, and a machined part.

FIG. 2 is a perspective view of the chip evacuator tool shown in FIG. 1.

FIG. 3A is a top view of the chip evacuator tool.

FIG. 3B is a bottom view of the chip evacuator tool.

### DETAILED DESCRIPTION

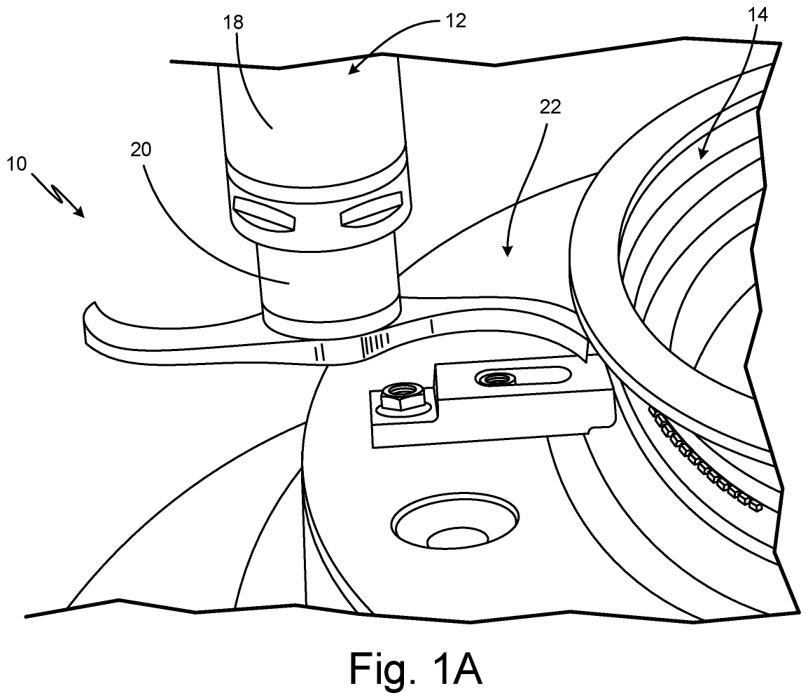

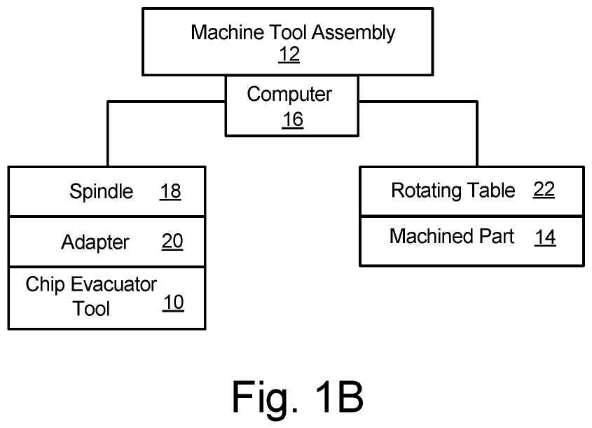

FIG. 1A is a perspective view of chip evacuator tool 10 installed in machine tool assembly 12. FIG. 1B is a schematic including chip evacuator tool 10, machine tool assembly 12, and machined part 14. FIGS. 1A and 1B will be discussed together. FIGS. 1A and 1B include chip evacuator tool 10, machine tool assembly 12, and machined part 14. Machine tool assembly 12 is a computer numerical control (CNC) machine that includes computer 16, spindle 18, adapter 20, and rotating table 22. Machine tool assembly 12 is a CNC machine in which computer 16 controls the translational movement and rotational direction/speed of spindle 18 and adapter 20. Further, computer 16 of the CNC machine also controls the rotational direction and speed of rotating table 22. Spindle 18 is a round shaft that rotates under the control of machine tool assembly 12 and includes standard features for attaching milling cutters and various other machining tools. Spindle 18 is translatable both in the vertical and horizontal direction, allowing spindle 18 to reach all portions of machined part 14. Adapter 20 is attached to spindle 18 using standard attachment features and facilitates the attachment of milling cutters or other machining tools that cannot connect directly to spindle 18 due to non-mating attachment features. Machined part 14 is attached to rotating table 22 using standard attachment means and rotates with rotating table 22 during the machining and finishing processes of machined part 14.

In the embodiment shown, machine tool assembly 12 includes spindle 18 and adapter 20, wherein adapter 20 is attached to and rotates with spindle 18. In another embodiment, machine tool assembly 12 can include only spindle 18 if spindle 18 has the appropriate fastening features to mate with chip evacuator tool 10. If machine tool assembly 12 does not include the appropriate fastening features, adapter 20 can be used to attach chip evacuator tool 10 to spindle 18 of machine tool assembly 12. In either embodiment, chip evacuator tool 10 is attached to spindle 18 or adapter 20 using standard fastening features, as will be discussed further below. Chip evacuator tool 10 is attached to and rotates with spindle 18 (either directly or through adapter 20), which is controlled by computer 16 of machine tool assembly 12.

After machined part 14 has been machined, chips are left behind that wrap around themselves and machined part 14, these chips need to be removed for inspection and final machining of machined part 14. To remove the chips from machined part 14, chip evacuator tool 10 is attached to either spindle 18 or adapter 20 and then controlled using computer 16 of machine tool assembly 12. Chip evacuator tool 10 is lowered into a position in which chip evacuator tool 10 is adjacent but not contacting machined part 14. Computer 16 of machine tool assembly 12 then sends a signal to begin rotating chip evacuator tool 10 in a first direction (clockwise as shown in FIG. 1A). Computer 16 of machine tool assembly 12 also sends a signal to rotating table 22, with attached machined part 14, to rotate in the first direction (clockwise). With rotating table 22 and machined part 14 in motion, the attached chips will come into contact with rotating chip evacuator tool 10 and the chips will be removed and discarded from machined part 14. In other words, chip evacuator tool 10 will catch or grab the chips and pull the chips away from machined part 14.

In the embodiment shown, the chips are removed from machined part 14 using chip evacuator tool 10. Further, during the chip removal process the location of spindle 18 and attached chip evacuator tool 10 remains stationary while spindle 18 rotates in a first direction and rotating table 22 and machined part 14 also rotate in the first direction. In another embodiment, machined part 14 could remain stationary while a rotating spindle 18 and attached chip evacuator tool 10 translates around the perimeter of machined part 14 and removes the chips from machined part 14. Further, in one embodiment rotating table 22 and machined part 14 rotate at a rate that is at least five times greater than the rate at which chip evacuator tool 10 rotates. During the chip removal process, rotating table 22 and machined part 14 rotate a plurality of times in an effort to ensure the chips have been removed from machined part 14 by the rotating chip evacuator tool 10.

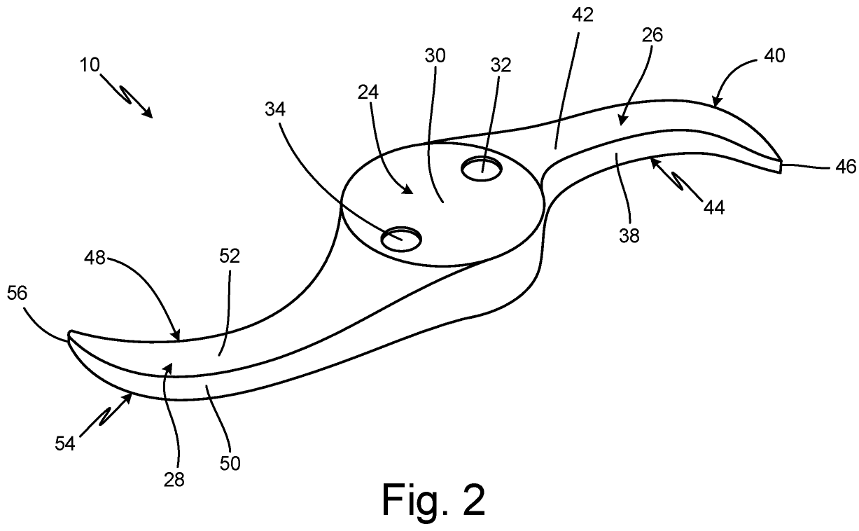

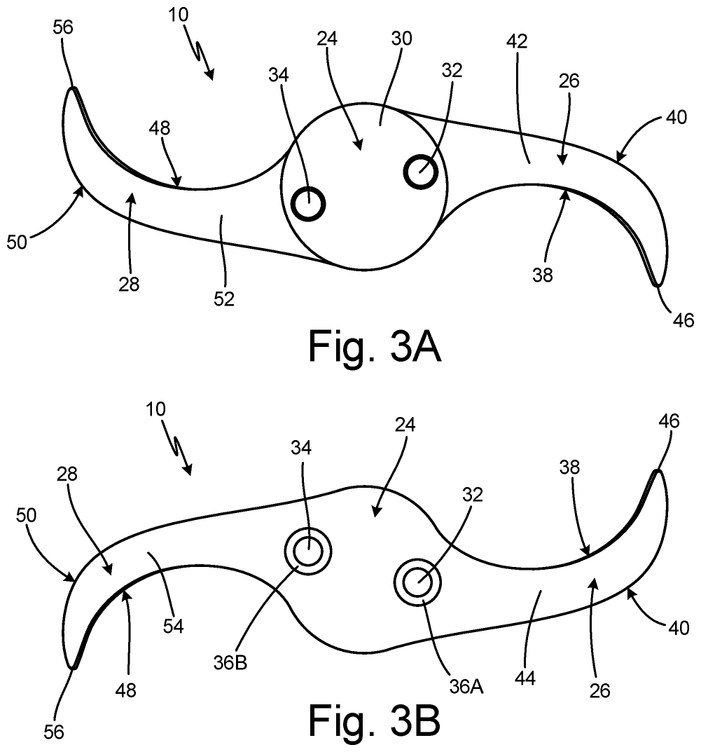

FIG. 2 is a perspective view of chip evacuator tool 10. FIG. 3A is a top view of chip evacuator tool 10 and FIG. 3B is a bottom view of chip evacuator tool 10. FIGS. 2, 3A, and 3B will be discussed together. Chip evacuator tool 10 includes circular body 24, first hook member 26, and second hook member 28. Circular body 24 includes flat surface 30, first aperture 32, second aperture 34, and counter bores 36A and 36B (shown in FIG. 3B). First hook member 26 includes first arcuate surface 38, second arcuate surface 40, first upper surface 42, first lower surface 44, and first tip 46. Second hook member 28 includes third arcuate surface 48, fourth arcuate surface 50, second upper surface 52, second lower surface 54, and second tip 56.

In the embodiment shown, chip evacuator tool 10 includes both first hook member 26 and second hook member 28. In another embodiment, chip evacuator tool 10 could include only first hook member 26 or chip evacuator tool 10 could include three or more hook members. The following disclosure will focus on the embodiment in which chip evacuator tool 10 includes both first hook member 26 and second hook member 28.

Circular body 24 includes flat surface 30, first aperture 32, second aperture 34, and counter bores 36A and 36B. Circular body 24 is the main body portion of chip evacuator tool 10 and provides a means for first hook member 26 and second hook member 28 to extend from. Further, circular body 24 includes flat surface 30 which is configured to mate with a corresponding flat surface of adapter 20 or spindle 18 (shown in FIG. 1A). First aperture 32 and second aperture 34 extend through circular body 24 and are configured to receive a fastener for securing chip evacuator tool 10 to adapter 20 or spindle 18. As best shown in FIG. 3B, counter bores 36A and 36B are positioned on a bottom surface of chip evacuator tool 10, extend partially through chip evacuator tool 10, and are configured to receive the head of the fasteners that are inserted in first aperture 32 and second aperture 34. In the embodiment shown, the fasteners that are used to secure chip evacuator tool 10 to adapter 20 or spindle 18 are bolts (not shown). In another embodiment, the fasteners can be any suitable fastener that can secure chip evacuator tool 10 to adapter 20 or spindle 18.

First hook member 26 includes first arcuate surface 38, second arcuate surface 40, first upper surface 42, first lower surface 44, and first tip 46. First hook member 26 extends from circular body 24 of chip evacuator tool 10 in a curved or bent angle configuration. First hook member 26 includes first arcuate surface 38, which is a curved surface that constitutes the inner surface of first hook member 26. First hook member 26 also includes second arcuate surface 40, which is a curved surface that constitutes the outer surface of first hook member 26. First arcuate surface 38 and second arcuate surface 40 both extend in a curved configuration until they converge at first tip 46. Further, first arcuate surface 38 and second arcuate surface 40 taper in the circumferential direction, in which first tip 46 is thinner in width than the location where first hook member 26 connects to circular body 24. Likewise, first upper surface 42 and first lower surface 44 taper in the radial direction, in which first tip 46 is thinner in height than the location where first hook member 26 connects to circular body 24. When in use, first hook member 26 is configured to catch hold of chips as first hook member 26 rotates with spindle 18. The curved configuration of first arcuate surface 38 and second arcuate surface 40 facilitate the grabbing and removal of chips from machined part 14. Further, the curved configuration helps keep the chips secure on chip evacuator tool 10 and does not allow the chips to slide off and escape chip evacuator tool 10.

Second hook member 28 includes third arcuate surface 48, fourth arcuate surface 50, second upper surface 52, second lower surface 54, and second tip 56. Second hook member 28 extends from circular body 24 of chip evacuator tool 10 in a curved or bent angle configuration. Second hook member 28 includes third arcuate surface 48, which is a curved surface that constitutes the inner surface of second hook member 28. Second hook member 28 also includes fourth arcuate surface 50, which is a curved surface that constitutes the outer surface of second hook member 28. Third arcuate surface 48 and fourth arcuate surface 50 both extend in a curved configuration until they converge at second tip 56. Further, third arcuate surface 48 and fourth arcuate surface 50 taper in the circumferential direction, in which second tip 56 is thinner in width than the location where second hook member 28 connects to circular body 24. Likewise, second upper surface 52 and second lower surface 54 taper in the radial direction, in which second tip 56 is thinner in height than the location where second hook member 28 connects to circular body 24. When in use, second hook member 28 is configured to catch hold of chips as second hook member 28 rotates with spindle 18. The curved configuration of third arcuate surface 48 and fourth arcuate surface 50 facilitate the grabbing and removal of chips from machined part 14. Further, the curved configuration helps keep the chips secure on chip evacuator tool 10 and does not allow the chips to slide off and escape chip evacuator tool 10.

First hook member 26 and second hook member 28 are positioned opposite one another about circular body 24. In other words, first hook member 26 and second hook member 28 are positioned approximately 180 degrees from each other around circular body 24. Further, as shown in FIGS. 2 and 3A-3B, first arcuate surface 38 and third arcuate surface 48 face away from each other. This results in both first hook member 26 and second hook member 28 being in an open configuration in which the inner surfaces (first arcuate surface 38 and third arcuate surface 48) are facing the direction of rotation. This allows first hook member 26 and second hook member 28 to both catch hold of and remove chips from machined part 14 when they come in contact with the chips.

In the embodiment shown, chip evacuator tool 10 is manufactured from a polycarbonate using an additive manufacturing process. In another embodiment, chip evacuator tool 10 can be manufactured using any suitable additive manufacturing or machining process that would result in the proper final geometry of chip evacuator tool 10. Further, in another embodiment, chip evacuator tool 10 can be manufactured from a metal, a thermoplastic polymer, or any other material that possess adequate material properties to withstand deformation while in use.

Chip evacuator tool 10 is used in a production machining process to automatically remove chips from machined parts, eliminating the need for manual removal by a machinist. The use of chip evacuator tool 10 eliminates the need to stop machine tool assembly 12 a plurality of times, increasing machine uptime and saving money in machining costs. Further, the use of chip evacuator tool 10 results in a safer machining process because the machinist is no longer required to reach into the machine to remove sharp chips from the machined part.

### Discussion of Possible Embodiments

The following are non-exclusive descriptions of possible embodiments of the present invention.

A chip evacuator tool includes a circular body with at least one aperture extending through the circular body. Further, the chip evacuator tool includes a first hook member extending from the circular body, wherein the first hook member includes a first arcuate surface and a second arcuate surface that converge at a first tip.

The chip evacuator tool of the preceding paragraph can optionally include, additionally and/or alternatively, any one or more of the following features, configurations and/or additional components:

The circular body includes two apertures extending through the circular body, and wherein each aperture includes a counter bore extending partially through the circular body.

The chip evacuator tool includes a second hook member extending from the circular body, and wherein the second hook member includes a third arcuate surface and a fourth arcuate surface that converge at a second tip.

The first hook member is positioned opposite the second hook member about the circular body, and wherein the first arcuate surface of the first hook member faces away from the third arcuate surface of the second hook member.

The circular body includes a flat surface configured to abut a spindle or an adapter of a machine tool assembly.

A chip removal system includes a machine tool assembly including a translatable spindle and a chip evacuator tool attached to the spindle. The chip evacuator tool includes a circular body including at least one aperture extending through the circular body, and a first hook member extending from the circular body, wherein the first hook member includes a first arcuate surface and a second arcuate surface that converge at a first tip. The machine tool assembly is a computer numerical control (CNC) system that is controlled using a computer.

The chip removal system of the preceding paragraph can optionally include, additionally and/or alternatively, any one or more of the following features, configurations and/or additional components:

The circular body includes two apertures extending through the circular body, and wherein each aperture includes a counter bore extending partially through the circular body.

The chip evacuator tool includes a second hook member extending from the circular body, and wherein the second hook member includes a third arcuate surface and a fourth arcuate surface that converge at a second tip.

The first hook member is positioned opposite the second hook member about the circular body, and wherein the first arcuate surface of the first hook member faces away from the third arcuate surface of the second hook member.

The circular body includes a flat surface configured to abut the spindle or an adapter of the machine tool assembly.

A method of removing chips from a machined part includes aligning a chip evacuator tool adjacent the machined part, rotating the chip evacuator tool in a first direction, rotating the machined part in the first direction, and removing the chips from the machined part using the chip evacuator tool. The chip evacuator tool comprises a circular body including at least one aperture extending through the circular body and a first hook member extending from the circular body, wherein the first hook member includes a first arcuate surface and a second arcuate surface that converge at a first tip.

The method of the preceding paragraph can optionally include, additionally and/or alternatively, any one or more of the following features, configurations and/or additional components:

Removing the chips from the machined part using the chip evacuator tool includes the first hook member catching or grabbing the chips and pulling the chips away from the machined part.

A computer system is used to align a position and control a rotational speed of the chip evacuator tool, and wherein the computer system is used to control a rotational speed of the machined part.

The circular body includes two apertures extending through the circular body, and wherein each aperture includes a counter bore extending partially through the circular body.

The chip evacuator tool includes a second hook member extending from the circular body, and wherein the second hook member includes a third arcuate surface and a fourth arcuate surface that converge at a second tip.

The first hook member is positioned opposite the second hook member about the circular body, and wherein the first arcuate surface of the first hook member faces away from the third arcuate surface of the second hook member.

The circular body of the chip evacuator tool includes a flat surface configured to abut a spindle or an adapter of a machine tool assembly.

Removing the chips from the machined part using the chip evacuator tool includes a location of the spindle remaining stationary while the spindle, connected chip evacuator tool, and machined part all rotate in the first direction.

The machined part rotates at a rate at least 5 times greater than a rate at which the chip evacuator tool rotates.

Removing the chips from the machined part using the chip evacuator tool includes the machined part completing a plurality of rotations.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A chip evacuator tool comprising:
a circular body including at least one aperture extending through the circular body; and
a first hook member extending from the circular body, wherein the first hook member includes a first arcuate surface and a second arcuate surface that converge at a first tip, and wherein the first hook member tapers in a circumferential direction such that a width of the first tip is less than a width of the first hook member at an interface of the first hook member and the circular body.

2. The chip evacuator tool of claim 1, wherein the circular body includes two apertures extending through the circular body, and wherein each aperture includes a counter bore extending partially through the circular body.

3. The chip evacuator tool of claim 1, wherein the chip evacuator tool includes a second hook member extending from the circular body, and wherein the second hook member includes a third arcuate surface and a fourth arcuate surface that converge at a second tip.

4. The chip evacuator tool of claim 3, wherein:
the first hook member is positioned 180 degrees from the second hook member about an axis extending through a center of the circular body;
the first arcuate surface of the first hook member faces in a first direction, the third arcuate surface of the second hook member faces in a second direction; and
the first direction is opposite the second direction.

5. The chip evacuator tool of claim 1, wherein the circular body includes a flat surface configured to abut a spindle or an adapter of a machine tool assembly.

6. A chip removal system for removing chips from a machined part, the chip removal system comprising:
a machine tool assembly including a translatable spindle; and
a chip evacuator tool attached to the spindle, the chip evacuator tool comprising a circular body including a first hook member extending from the circular body, wherein the first hook member includes a first arcuate surface and a second arcuate surface that converge at a first tip that is free from contact, and wherein the first hook member is configured to grab and pull chips away from the machined part to remove the chips from the machined part;
wherein the machine tool assembly is a computer numerical control (CNC) system.

7. The chip removal system of claim 6, wherein the circular body includes two apertures extending through the circular body, and wherein each aperture includes a counter bore extending partially through the circular body.

8. The chip removal system of claim 6, wherein the chip evacuator tool includes a second hook member extending from the circular body, and wherein the second hook member includes a third arcuate surface and a fourth arcuate surface that converge at a second tip.

9. The chip removal system of claim 8, wherein:
the first hook member is positioned 180 degrees from the second hook member about an axis extending through a center of the circular body;
the first arcuate surface of the first hook member faces in a first direction, the third arcuate surface of the second hook member faces in a second direction; and
the first direction is opposite the second direction.

10. The chip removal system of claim 6, wherein the circular body includes a flat surface configured to abut the spindle or an adapter of the machine tool assembly.

11. A method of removing chips from a machined part comprising:
aligning a chip evacuator tool adjacent the machined part;
rotating the chip evacuator tool in a first direction;
rotating the machined part in the first direction; and
grabbing and removing the chips from the machined part using the chip evacuator tool;
wherein the chip evacuator tool comprises a circular body including a first hook member extending from the circular body, wherein the first hook member includes a first arcuate surface and a second arcuate surface that converge at a first tip, and wherein the first hook member tapers in a circumferential direction such that a width of the first tip is less than a width of the first hook member at an interface of the first hook member and the circular body.

12. The method of claim 11, wherein removing the chips from the machined part using the chip evacuator tool includes the first hook member catching or grabbing the chips and pulling the chips away from the machined part.

13. The method of claim 11, wherein a computer system is used to align a position and control a rotational speed of the chip evacuator tool, and wherein the computer system is used to control a rotational speed of the machined part.

14. The method of claim 11, wherein the circular body includes two apertures extending through the circular body, and wherein each aperture includes a counter bore extending partially through the circular body.

15. The method of claim 11, wherein the chip evacuator tool includes a second hook member extending from the circular body, and wherein the second hook member includes a third arcuate surface and a fourth arcuate surface that converge at a second tip.

16. The method of claim 15, wherein the first hook member is positioned opposite the second hook member about the circular body, and wherein the first arcuate surface of the first hook member faces away from the third arcuate surface of the second hook member.

17. The method of claim 11, wherein the circular body of the chip evacuator tool includes a flat surface configured to abut a spindle or an adapter of a machine tool assembly.

18. The method of claim 17, wherein removing the chips from the machined part using the chip evacuator tool includes a location of the spindle remaining stationary while the spindle, connected chip evacuator tool, and machined part all rotate in the first direction.

19. The method of claim 11, wherein the machined part rotates at a rate at least 5 times greater than a rate at which the chip evacuator tool rotates.

20. The method of claim 11, wherein removing the chips from the machined part using the chip evacuator tool includes the machined part completing a plurality of rotations.
